(19) United States
(12) Patent Application Publication
(10) Pub. No.: US 2015/0289329 A1
(43) Pub. Date: Oct. 8, 2015

(54) Lighting Control System Using Input Voltage Dependent Control

(71) Applicant: Jade Sky Technologies, Inc., Milpitas, CA (US)

(72) Inventors: Aaron M. Schultz, San Jose (US); Eugene L. Cheung, Fremont (US)

(73) Assignee: Jade Sky Technologies, Inc., Milpitas, CA (US)

(21) Appl. No.: 14/248,268

(22) Filed: Apr. 8, 2014

(51) Int. Cl. H05B 33/08

(52) U.S. Cl. CPC H05B 33/0812

(57) ABSTRACT

A method and apparatus for controlling gain factor in a driver device for a lighting device according to the input voltage signal to reduce output current or output power dependency on the amplitude of the input voltage signal. One method couples an input voltage signal to the input port of the driver device and couples an output branch to the output port of the driver device. The gain factor is adjusted according to the input voltage signal to reduce output current or output power dependency on input voltage amplitude of the input voltage signal. The gain factor can also be configured according to a reference voltage and the output voltage across the output port to deliver a substantially constant output power.

### CROSS REFERENCE TO RELATED APPLICATIONS

The present invention is related to U.S. Pat. No. 8,581,498, issued on Nov. 12, 2013, entitled “Control of bleed current in drivers for dimmable lighting devices” and U.S. Pat. No. 8,525,438, issued on Sep. 3, 2013, entitled “Load driver with integrated power factor correction”. The U.S. Patents are hereby incorporated by reference in their entireties.

### FIELD OF THE INVENTION

This invention pertains to the field of driver circuits for driving LEDs (Light Emitting Diodes), which may or may not couple with dimmers.

### BACKGROUND AND RELATED ART

The use of high-brightness LEDs in lighting applications is growing rapidly as a result of inherent benefits to LED technology, such as long lifetimes, good efficiency, and non-toxic material usage. LED lighting solutions, however, still need to offer better performance at better value. Because LEDs prefer to be driven in a different fashion as compared to traditional incandescent bulbs, performance depends heavily on the LED driver circuit.

Traditional LED driver ICs (integrated circuits) suffer in performance and features in several ways. First, the driver efficiency generally falls short of the target. Similarly, the power factor for existing solutions can be quite poor, especially in a dimming configuration. When using the TRIAC-based wall dimmers that are typical in existing installations, conventional solutions may cause annoying flicker while dimming.

Further difficulties arise when retrofitting existing applications with LED fixtures. Retrofitting requires compatibility with the large installed base of dimmers, particularly leading-edge TRIAC-based dimmers. Because these dimmers were commonly designed for current levels much higher than those consumed by LED applications, many problems occur with existing LED driver solutions.

TRIAC-based dimmers function by allowing current to pass during a fraction of the half-cycle of the input AC mains voltage. One of the most common types of TRIAC dimmers is the leading-edge type, which initially turns on at some point past the zero-crossing of the AC waveform (in both the upward direction and the downward direction), and then turns off at the next zero-crossing.

Most leading-edge TRIAC-based dimmers were designed for use with incandescent light bulbs. In order to turn on and power the bulb, the TRIAC requires a latching current to flow through the load. Subsequently, to maintain the TRIAC's On state until the next AC zero-crossing, a holding current must be present. This TRIAC behavior matches well with the strongly positive temperature coefficient of incandescent bulbs. When cold and unpowered, an incandescent bulb presents a filament resistance which is a fraction of its value when powered. As current and power dissipation increase, temperature and hence resistance increase greatly. By its nature, the incandescent bulb provides a large latching current at the time of turn on, and maintains a lesser holding current while lit. Since one of the advantages of LED-based incandescent bulb replacements is power efficiency, it naturally draws less current than the hot incandescent bulb, and much less than the cold incandescent bulb.

TRIAC-compatible LED drivers may dissipate more power. Even with the degraded efficiency due to a bleed of either constant current or constant resistance, many driver solutions fail in terms of gross functionality with digitally-controlled TRIAC-based dimmers. The digitally-controlled TRIAC-based dimmers require low load impedance even in the standby state. Therefore, when the dimmer is not explicitly powering the driver yet, the dimmer needs to keep standby circuits inside the dimmer alive. In U.S. Pat. No. 8,581,498, a dimmer compatibility device has been disclosed to address these dimmer compatibility problems.

Typical LED driver solutions that use standard closed loop control on the LED current suffer dimmer compatibility problems. The combination of dimmer and current control loop dynamics results in various problems such as flicker, flashing, always-On, cycling, never-On, and other obnoxious behaviors in commercially available LED bulbs.

Unfortunately, a reduction of complexity in order to avoid dimmer and current control dynamics can suffer from output current inaccuracy. In U.S. Pat. No. 8,525,438, a simple high power factor LED driver over entire dimming range has been disclosed. However, the nature of its simplicity leads to output current variation with changes in component values and AC line voltage.

The LED's forward voltage V_{f} can vary at the same current. As a consequence, standard current drive LED circuits must be overdesigned. The power electronics and heat sinking must be able to handle any possible output power, as present at the maximum V_{f} for a given current. When the electronics and heat sinking are designed to handle this maximum power, then the electronics and heat sinking become overdesigned for the nominal and minimum V_{f} case. Accordingly, it is desirable to design a driver for LEDs where the driver is able to optimize the design of the power electronics and heat sink.

### SUMMARY OF INVENTION

A method and apparatus are disclosed for controlling gain factor in a driver device for a lighting device according to the input voltage signal to reduce output current or output power dependency on the amplitude of the input voltage signal. One method incorporating an embodiment of the present invention couples an input voltage signal to the input port of the driver device (also called a power converter system in this disclosure) and an output branch to the output port of the driver device. The input voltage signal corresponds to a rectified voltage signal. The gain factor is adjusted according to the input voltage signal to reduce output current or output power dependency on input voltage amplitude of the input voltage signal, wherein the gain factor corresponds to a ratio of the output current to the input voltage of the driver device. In another embodiment, the gain factor is configured according to a reference voltage and the output voltage across the output port to deliver a substantially constant output power.

Various exemplary system configurations are disclosed. For example, the gain factor can be inversely proportional to the input voltage amplitude; this will cause substantially constant output current for a driver device incorporating non-isolated buck power conversion or cause substantially constant output power for a driver device incorporating isolated flyback or non-isolated buck-boost power conversion. The input voltage amplitude can be determined based on the input voltage signal using a peak detector.

When the reference voltage (V_{ref}) and the output voltage (Vₒᵤₜ) are used, the gain factor can be configured to include a term proportional to (1+(V_{ref}−Vₒᵤₜ)/V_{ref}).

The gain factor adjustment can be implemented using a variable resistance. The variable resistance can be used with a resistor to form a voltage divider and to form a control signal across the variable resistance for controlling power conversion, where the resistance of the resistor is substantially larger than the variable resistance. The variable resistance can be implemented by imposing a force current and a force voltage on a circuit. For example, the circuit may comprise one or more MOSFETs (metal-oxide-semiconductor field-effect-transistor).

A driver device according to the present invention may also be used with a dimmer compatibility device to sink required current for proper dimmer operation by connecting the dimmer compatibility device and the driver device to the dimmer.

### BRIEF DESCRIPTION OF THE DRAWINGS

FIG. 1 illustrates a conventional driver device with a fixed scaled gain for driving a lighting device.

FIG. 2 illustrates an exemplary driver device for driving a lighting device by adjusting the gain according to the input voltage signal in order to reduce the output current or output power dependency on the voltage amplitude of the input voltage signal.

FIG. 3 illustrates an exemplary driver device for driving a lighting device by setting the gain inversely proportional to the voltage amplitude of the input voltage signal in order to remove the output current or output power dependency on the voltage amplitude of the input voltage signal.

FIG. 4 illustrates an exemplary driver device for driving a lighting device by adjusting the gain according to a reference voltage and the output voltage to deliver a substantially constant output power.

FIG. 5 illustrates an exemplary driver device for driving a lighting device by setting the gain proportional to (1+(V_{ref}−Vₒᵤₜ)/V_{ref}) to deliver a substantially constant output power.

FIG. 6 illustrates an exemplary driver device for driving a lighting device by adjusting the gain according to the input voltage signal as well as the reference voltage and the output voltage to reduce output power dependency on the input voltage amplitude and to deliver a substantially constant output power.

FIG. 7 illustrates an example of using a voltage divider comprising a variable resistance to derive the control signal for power conversion.

FIG. 8 illustrates an example of providing a variable resistance by imposing a force current and a force voltage to a variable resistance device.

FIG. 9 illustrates a first part of an exemplary schematic for forming a variable resistance device.

FIG. 10 illustrates a second part of an exemplary schematic for forming a variable resistance device.

FIG. 11 illustrates an exemplary schematic of a driver device for controlling a lighting device to achieve constant output power, where the driver device uses flyback or buck-boost power conversion and the gain is inversely proportional to the input voltage amplitude.

FIG. 12 illustrates an exemplary system configuration for controlling lighting device, where a driver device incorporating an embodiment of the present invention and a dimmer compatibility device are coupled to a dimmer device in parallel.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely a representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

FIG. 1 shows an exemplary configuration of a conventional power converter system (11) for LED lighting control. The term of power converter system is used interchangeably with the driver device in this disclosure. An integrated approach to power factor correction is achieved by sampling the rectified line input Vin (10) from the AC mains, and by using that waveform to control the current flowing through output branch. In this way, the output current (12) follows the line input voltage Vin waveform shape, thereby yielding a good power factor. The output branch in

FIG. 1 consists of capacitor 13 and LED string 14. In FIG. 1, input voltage 10 with peak amplitude Vpk enters the power converter system (11). Power converter system (11) converts Vin into output current 12 in the output branch. Output current 12 is equal to a scaled version of the input voltage. Gain factor for the circuit in FIG. 1 is G0 with the unit Amps per Volt:

Output Current(t)=G0*Vin(t)=G0*Vpk*y(t) (1)

With the power converter system of FIG. 1, output current 12 in the output branch resembles the shape of the input voltage (10). In fact, with the scalar gain factor G0, the branch current (12) should have the exact same shape as the input voltage (10).

The output current 12 flows to the load that incorporates capacitor 13 and LED string 14. The capacitor 13 sinks most of the AC attribute of the output current in output branch, leaving the mostly DC current to flow through LED string 14.

Examination of the relationship between output current and input voltage reveals a dependence on the amplitude Vpk. This output dependence on input amplitude is undesirable. The name for this dependence is “line sensitivity.” How well a power converter system, such as system 11 in FIG. 1, outputs a current independent of the input voltage amplitude is called “line regulation.” Inability of a converter to render its output independent of the input amplitude is poor line regulation.

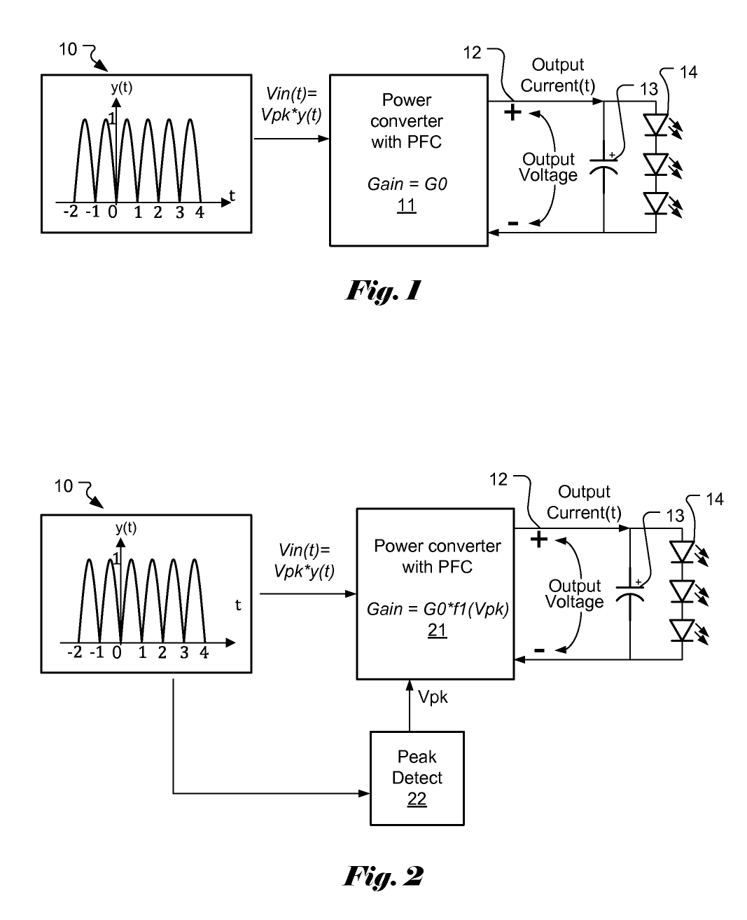

In order to avoid said poor line regulation, the gain factor is modified, as shown in FIG. 2. A new gain factor depends on the amplitude, Vpk. FIG. 2 shows a driver circuit incorporating an embodiment of the present invention that includes peak detection 22. The output of this peak detection circuit (22) is the maximum voltage of the input signal (10). The detected voltage, Vpk is provided to the power converter system (21), which, converts power from the input AC voltage (10) to an output current (12) in the output branch.

Output Current(t)=G0*f1(Vpk)*Vpk*y(t) (2)

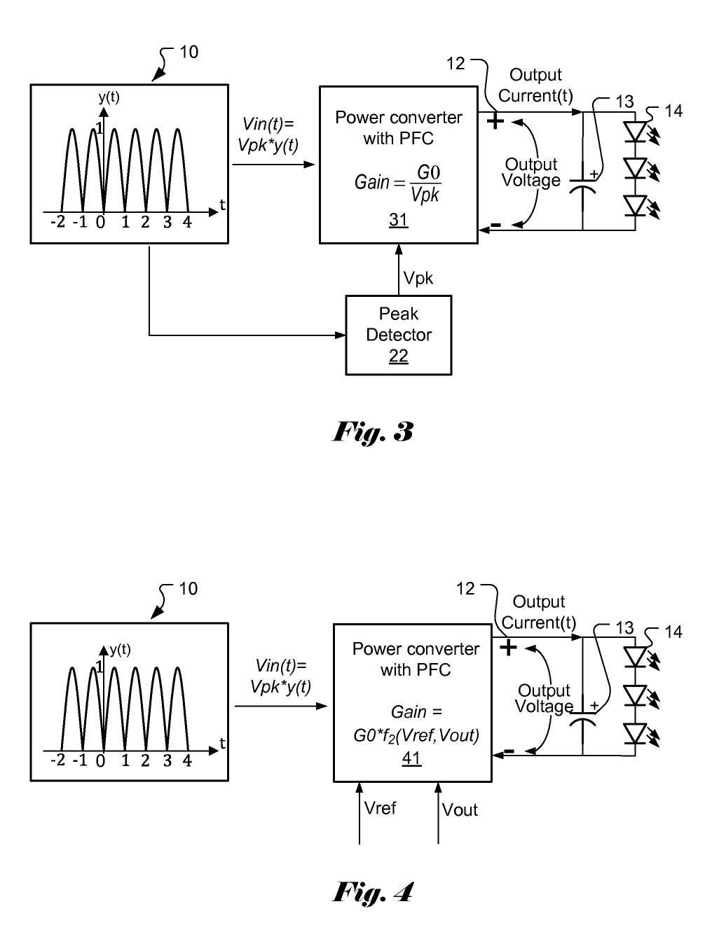

Power converter system 31 of FIG. 3 explicitly sets the gain factor. FIG. 3 shows the gain factor, Gain is configured according to Gain=G0/Vpk. With Vpk term reciprocally in the gain factor, then Vpk will effectively be eliminated from the magnitude of output current 12. The equation for output current becomes:

$$Output Current ( t ) = \frac{G 0}{Vpk} * Vpk * y ( t ) = G 0 * y ( t ) , \qquad ( 3 )$$

which is independent of Vpk. While peak detection 22 is shown external to power converter system 31, the peak detection circuit may also be incorporated into the power converter system as part of the power converter system.

Noteworthy is that the peak voltage Vpk directly affects the gain factor. Such a change in the gain factor based on a parameter is called “feedforward.” So long as the peak remains consistent, there is substantially no dynamic introduced into the current control. Line regulation of the output current in this case does not utilize additional feedback. If feedback were to be used, then control signals in a closed loop change the power conversion to counteract input voltage amplitude differences. This kind of closed loop feedback makes sense when the input voltage is always a full sine wave; it becomes problematic with dimming systems.

The off-line LED power converters under discussion typically control their inductor current. When an inductor directly connects the output of such a converter, the converter effectively controls the output current. Such is the case in a so-called “buck” converter, whose inductor is at the output. In buck converter applications that demand constant output current, there is no need for output voltage to be used in the gain factor as discussed above.

Yet there are other scenarios wherein the output voltage matters. For example,
Current in a flyback or buck-boost converter main magnetic storage device does not translate to output current. Instead, it translates to power. Control of a flyback or buck-boost magnetic storage element current means control of power. To ensure a constant output current in the context of power control, the power target needs to take into account the output voltage. Accordingly, by changing the output power target as a function of output voltage, output current control can be effectively achieved.
A buck converter application may desire to control output power rather than output current. Because the inductor connects to the output, inductor current control translates directly to output current control. In order to control output power, the output current target needs to change as a function of the voltage. By changing the output current as a function of output voltage, output power control can be achievable.

FIG. 4 presents another power converter system 41 that receives additional input signals, Vref and Vout, where Vref is a reference voltage provided externally and Vout is the output voltage from the power converter system. The reference voltage may correspond to a target output voltage, such as the expected voltage of an LED string. Vout is the actual output voltage across an LED string. These inputs allow for the possibility of modifying the gain factor, Gain to be dependent on input signals, Vref and Vout:

Output Current(t)=G0*f2(Vout, Vref)*Vpk*y(t) (4)

In eqn. (4), f₂(.) is a function with Vref and Vout as variables. FIG. 5 explicitly determines how the new gain factor, Gain in power converter system 51 depends on Vref and Vout. Specifically, the gain factor is configured to be equal to:

G0*(1+((Vref−Vout))/Vref). (5)

With this gain factor, the output current (12) in the output branch becomes:

$$Output Current ( t ) = G 0 * ( 1 + \frac{( Vref - Vout )}{Vref} ) * Vpk * y ( t ) \qquad ( 6 )$$

Just as in the power converter system (31) of FIG. 3, the power converter system (51) of FIG. 5 does not add additional current feedback. Simply, the voltages Vref and Vout are provided to the power converter system (51); gain factor, Gain changes accordingly. The output current includes the dependence on voltages Vref and Vout via the gain factor.

The power converter system in FIG. 5 is capable of maintaining the output power at a desired level. For example, LED string 14 may be 30 Volts and this LED voltage becomes the output voltage of a buck converting LED driver. Output current may be 300 mA. Total power is 9 Watts for this output branch. If the output voltage increases to 33 V (i.e., 10% increase), the output power will also increase by 10% (300 mA*33V=9.9W). In order to configure the power converter system to deliver a desired output power, Vref can be set to 30 Volts. When the actual output voltage, Vout increases to 33V, the gain factor, Gain will be reduced by 10% according to gain factor in eqn. (5) (i.e., 1+(30−33)/30)=0.9). And so the current commanded at 33 Volts would decrease by 10%.

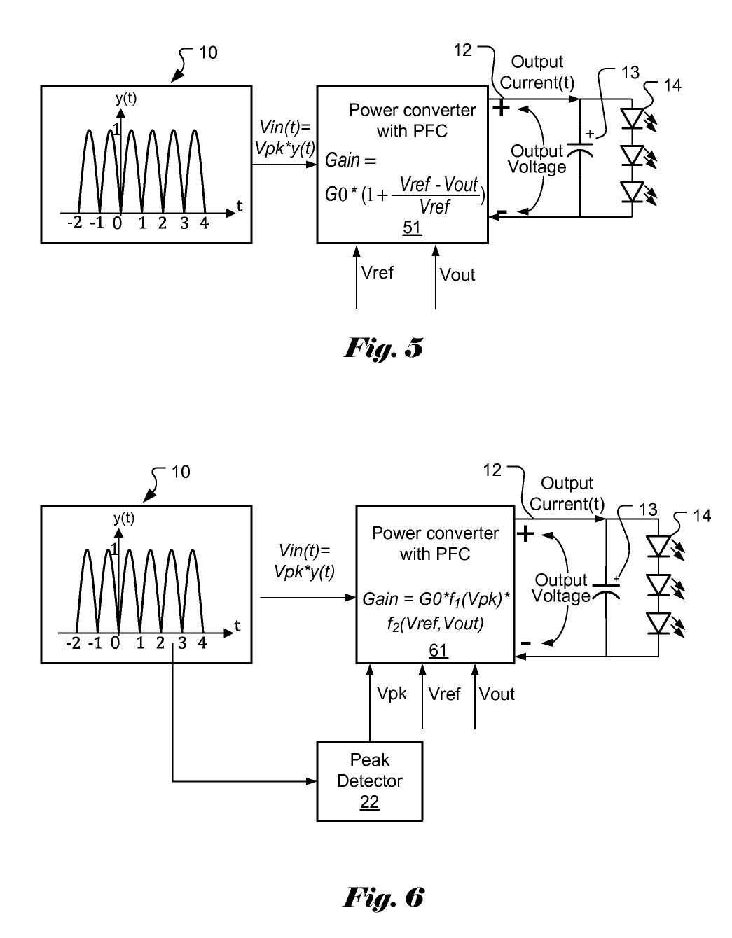

FIG. 6 combines all of the previous gain adjustments into new power converter 61 with gain factor,

Gain=G0*f₁(Vpk)*f₂(Vref ,Vout). (7)

In other words, the gain factor according to the system of FIG. 6 is proportional to function, f₁(Vpk) and function, f₂(Vref,Vout). The output current of this scheme is,

Output Current(t)=G0*Vpk*f₁(Vpk)*f₂(Vref,Vout)*y(t) (8)

All of the power converter systems as shown in FIG. 1 through FIG. 6 use the architecture to provide an output current depending on an AC input voltage. This input voltage is multiplied by a gain factor. The gain factor can be configured according to the input voltage as described in various embodiments according to the present invention. One embodiment of this adjustable gain is based on variable resistance. For example, a resistor divider may be used to provide variable resistance. The gain factor of the voltage can be changed if one of the resistances (e.g., of the bottom device) of the resistor divider is changed.

FIG. 7 shows a diagram with variable resistor 73 that may reside inside or outside control system 71. Resistance of resistor 73 may be much less than the resistance of resistor 75, which may reside outside the control system 71. The value of resistance of adjustable resistor 73 is adjusted according to adjustment 74. Resistance adjustment 74 can be based on f₁ or both f₁ and f₂. The resulting control voltage (76) is provided to the power conversion block (72). Power conversion block 72 then controls the output current (12) of the output branch by providing the following control voltage:

$$\begin{matrix}control\_voltage ( t ) = Vpk * y ( t ) * \frac{Radj}{Radj + Rext} \approx Vpk * y ( t ) * \frac{Radj}{Rext} , \\ where Radj ≪ Rext . & ( 9 ) \\ & \end{matrix}$$

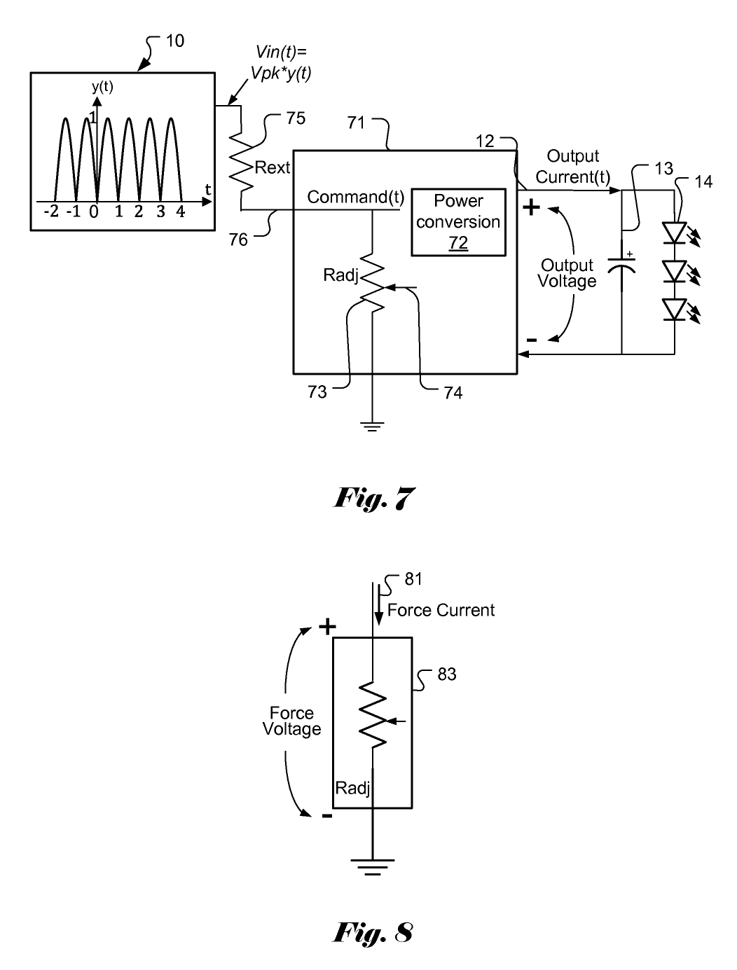

An adjustable resistance device can be implemented by imposing a force current (81) and a force voltage on a device 83 as shown in FIG. 8. The power converter systems disclosed above can then use this device so conditioned to provide desired gain factor. The device, or a mirrored device, can substitute the adjustable resistance (73) in FIG. 7. The force current can be set to C0*Vpk and the force voltage can be set to Vref+(Vref−Vout) according to one embodiment of the present invention. Accordingly, the force current and the force voltage will produce an effective adjustable resistance, Radj equal to:

$$Radj = \frac{Vref + ( Vref - Vout )}{C 0 * Vpk} . \qquad ( 10 )$$

In the above example, the control voltage(t) becomes:

$$control\_voltage ( t ) ≅ y ( t ) * \frac{Vref + ( Vref - Vout )}{C 0 * Rext} . \qquad ( 11 )$$

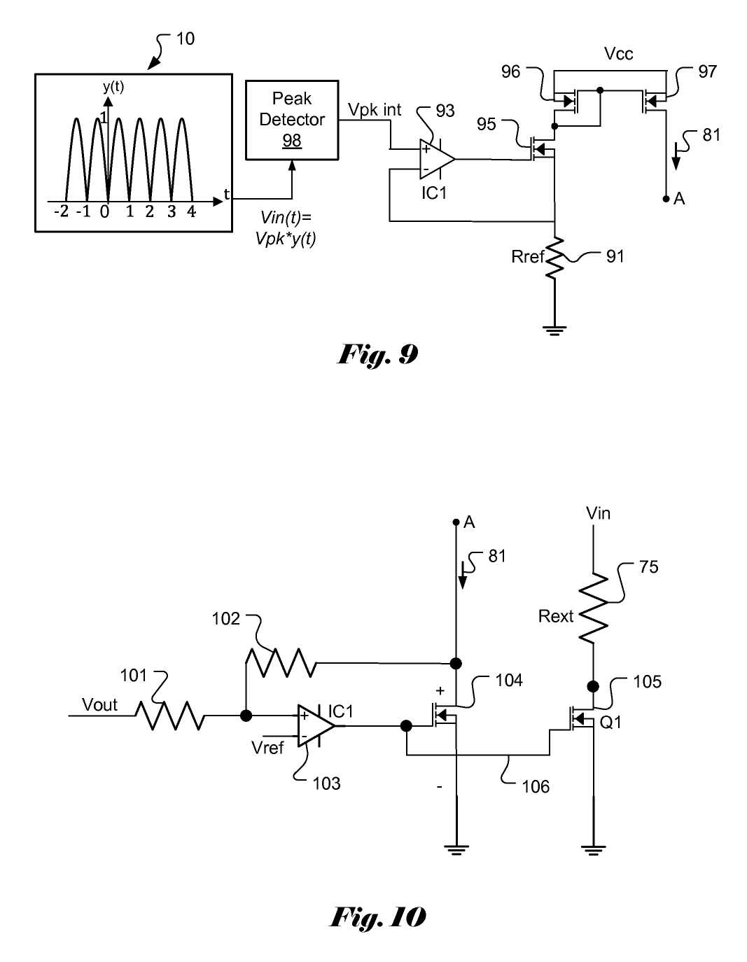

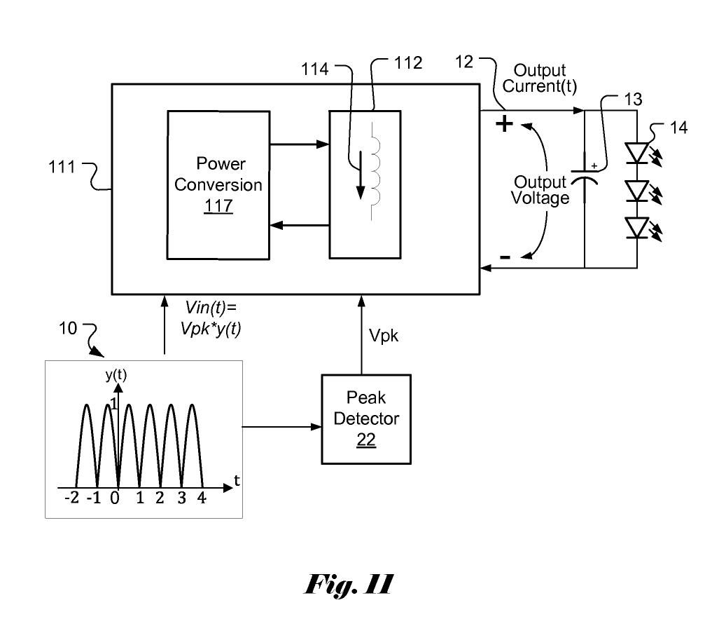

FIGS. 9 and 10 illustrate exemplary schematics for implementing the adjustable resistance (83) of FIG. 8. In FIG. 9, peak detector 98 outputs a voltage signal, Vpk_int proportional to the peak of input voltage 10. The circuit employs a source follower configured to force this voltage signal, Vpk int across reference resistor 91. The circuit uses operational amplifier 93, which controls the gate of N-channel MOSFET 95. The resulting current through reference resistor 91 is mirrored by use of P-channel MOSFETs 96 and 97. Output current 81, then, depends linearly on Vpk.

In FIG. 10, output current 81 is fed into N-channel MOSFET 104. With resistances of 101 and 102 equal to each other, feedback control with Op Amp 103 forces the voltage on the drain of MOSFET 104 to be equal to Vref+(Vref−Vout). The combination of the drain voltage and drain current of MOSFET 104 realizes a device modeled as an adjustable resistor. The device modeled as a resistor is called a “synthetic resistor” In this disclosure. By forcing the drain voltage and drain current of MOSFET 104, the MOSFET becomes a synthetic resistor.

A few key assumptions must hold true for device 104 to work as a synthetic resistor.
The drain-to-source voltage of device 104 must be low enough for the MOSFET to be in the linear region, i.e., Vds<Vgs−Vt, where Vgs is the gate-to-source voltage and Vt is the threshold voltage. In the case of a silicon MOSFET, Vds<=0.3 V will suffice.
The series combination of resistances of 101 and 102 in the op amp circuit must be much larger than the On resistance of MOSFET 104. This condition will be valid almost by definition, when MOSFET 104 is in the linear region so long as the device is large enough.

FIG. 10 shows a connection (106) between the gate of MOSFET 104 and the gate of MOSFET 105. The configuration will force MOSFET 105 to be a synthetic resistor also. If the gate voltage of MOSFET 105 matches the gate voltage of MOSFET 104, and the drain voltage of MOSFET 105 is small enough, then MOSFET 105 will indeed be a synthetic resistor with matching resistance. In other words, MOSFET 105 will be in the linear region, like MOSFET 104. To maintain a low drain voltage at MOSFET 105, the following condition must hold:
Resistor Rext (75) must be large enough that the voltage at the drain of MOSFET 105 is small, for example 0.3 Volts in the case of silicon transistors. With small Vds, MOSFET 105 will be in the linear region with same gate voltage as MOSFET 104. The linear region of operation ensures that the scaled control signal (76) in FIG. 7 is a scaled version of input signal 10, which in turn results in an optimal power factor.

Assuming all of the above conditions hold, then the resistor divider consisting of Rext and the synthetic resistor (i.e., MOSFET 105) form the desired scaling factor shown in FIG. 7. MOSFET 105 implements the resistor device (73) in FIG. 7.

As discussed previously, control of the current in a magnetic storage device within a flyback or buck-boost converter amounts to output power control rather than output current control. These power circuits are so-called “indirect” converters. The principle of delivering power for these circuits is by first loading energy into a magnetic storage device that is connected to an input source, and then releasing the energy to the output with the input disconnected. This process repeats at a given frequency.

FIG. 11 illustrates an exemplary system incorporating a magnetic storage device and associated control. Power converter system 111 controls the current (114) of the magnetic storage device (112). Control and power block 117 manages the current 114 in magnetic storage device 112. Control and power block 117 and magnetic storage device 112 interface with each other through bidirectional connection. Control and power block 117 corresponds to a power converter system less the magnetic storage device. Magnetic storage device 112 can be characterized by inductance L. The current (114) through the magnetic storage device is named Iₗ. Due to the constitutive law, Energy=½*L*Iₗ² and with Power=Energy*frequency, the control of current in magnetic storage device 112 then translates to power control of power converter system 111.

Power converter system 111 incorporates an exemplary gain factor G1/Vpk. To represent power control, the gain equation includes term G1 of units Watts per Volts. By using an embodiment disclosed above, gain factor can incorporate the term, 1/Vpk so that converter output power becomes independent of the amplitude of input voltage. In this case, the output current is not under control. Instead, output power is controlled and the magnitude of output current depends on the output voltage as shown in eqn. (12) and eqn. (13).

$$\begin{matrix}Output Power ( t ) = G 1 * y ( t ) , & ( 12 ) \\ Output Current ( t ) = \frac{Output Power ( t )}{Output Voltage ( t )} . & ( 13 )\end{matrix}$$

Consideration of the foregoing disclosure reveals an embodiment of a variable multiplier. In FIG. 8, the multiplication, or the gain factor, of the power converter system begins with adjustable resistor 83. If the resistance of adjustable resistor 83 can change, then the gain factor can change. FIG. 7 indicates that for Radj<<Rext, the gain factor can be approximated as Radj/Rext. Since the external resistor Rext is fixed, Radj becomes a variable multiplier in the system. Also novel in the present invention is that input voltage amplitude and the output voltage can independently and simultaneously change the gain factor. Voltage and current of device 104 in FIG. 10 are independently derived. The voltage of device 104 depends on reference voltage and output voltage as shown in FIG. 4. Current in device 104 depends on the peak amplitude of the input voltage. Thus two independent parameters can vary the single gain factor.

For power converters such as a buck whose output current is under control, the determining elements of adjustable resistor 83 combine to effect power control. Yet there is no direct sense of power. This method is different from the more standard, expensive, analog to digital conversion method with subsequent digital multiplication. More typically for true power control, sensed power is used in a discrete time control feedback loop, with analog to digital and digital to power conversions required. Instead, the present invention uses feedforward to change the control signal, and as a result can achieve low cost power regulation without introducing system dynamics that interfere with dimmer compatibility.

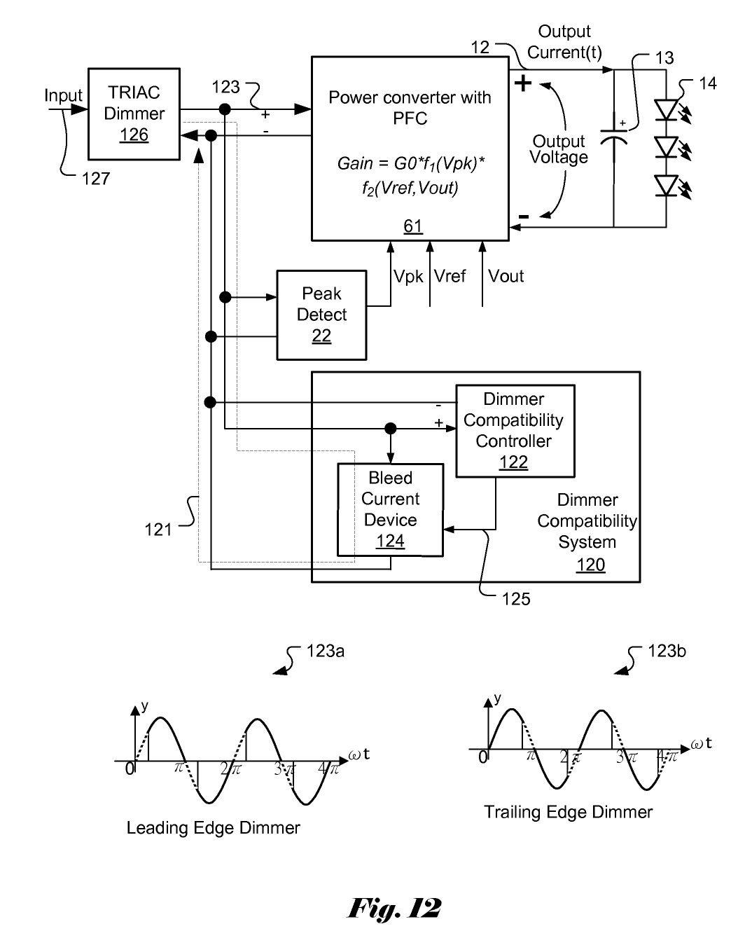

As shown in FIG. 12, it is possible to combine embodiments of power converter system according to the present invention with dimmer compatibility circuitry. For example, the dimmer compatibility system as disclosed in U.S. Pat. Ser. No. 8,581,498 can be combined with the power converter system as disclosed above. As shown in FIG. 12, dimmer compatibility system 120 is connected in parallel with power converter system 61 at the signal input end. Dimmer compatibility system 120 coupled to the TRIAC dimmer will sink the current (121) as needed from the TRIAC dimmer (126) in order to keep the TRIAC dimmer (126) operating properly. Input voltage 123 may be of different forms based on a given TRIAC dimmer (examples shown as 123a and 123b in FIG. 12). Input voltage 123 is created by the action of the dimmer 126 chopping the AC input voltage 127. Dimmer compatibility controller 122 controls bleed current device 124 in the dimmer compatibility system 120. Bleed current 121 flows from the input 127, through dimmer device 126, through the bleed current device 124, and back to dimmer device 126 and input 127. Dimmer compatibility controller 122 uses the input voltage (123) to configure the bleed current device (124) via control signal 125. Because this dimmer compatibility circuit can operate independently, there is very little systematic interaction between lighting control system 61 and dimmer compatibility system 120. Such a combination enables superior dimmer compatibility while providing the benefits described in this disclosure.

This present invention manages the broad area of problems in conventional power converter systems for LED lighting control. It combines dimmer compatibility with high power factor drive and high output current accuracy. The resulting solution is a clean architecture that adds accuracy not provided by U.S. Pat. No. 8,525,438, while maintaining the ability to use methods of U.S. Pat. No. 8,581,498 to ensure dimmer compatibility.

The invention may be embodied in other specific forms without departing from its spirit or essential characteristics. The described examples are to be considered in all respects only as illustrative and not restrictive. Therefore, the scope of the invention is indicated by the appended claims rather than by the foregoing description. All changes which come within the meaning and range of equivalency of the claims are to be embraced within their scope.

1. A method of controlling gain factor in a power converter system for a lighting device, said method comprising the steps of:
coupling a input voltage signal to an input port of the power converter system;
coupling the light device to an output port of the power converter system; and
configuring the gain factor of the power converter system according to the input voltage signal to reduce output current or output power dependency on input voltage amplitude of the input voltage signal, wherein the gain factor corresponds to a ratio of the output current to the input voltage of the power converter system.

2. The method of claim 1, wherein the gain factor is inversely proportional to the input voltage amplitude.

3. The method of claim 2, wherein the gain factor causes substantially constant output current for the power converter system incorporating non-isolated buck power conversion or causes substantially constant output power for the power converter system incorporating isolated flyback or non-isolated buck-boost power conversion.

4. The method of claim 2, wherein the input voltage amplitude is determined based on the input voltage signal using a peak detector.

5. The method of claim 1, wherein said configuring the gain factor corresponds to adjusting a variable resistance.

6. The method of claim 5, wherein the variable resistance and a first resistor form a voltage divider, and a control signal for power conversion is obtained across the variable resistance.

7. The method of claim 1, wherein the gain factor is further configured according to a reference voltage and an output voltage across the output port to deliver a substantially constant output power.

8. The method of claim 7, wherein the gain factor is configured to include a term proportional to (1+(V_{ref}−Vₒᵤₜ)/V_{ref}), wherein V_{ref} corresponds to the reference voltage and Vₒᵤₜ corresponds to the output voltage.

9. The method of claim 1 further comprising coupling the input voltage signal to a dimmer compatibility device to sink required current for proper dimmer operation.

10. A method for controlling gain factor in a power converter system for a lighting device, said method comprising the steps of:
coupling a input voltage signal to an input port of the power converter system based on non-isolated buck power conversion;
coupling the light device to an output port of the power converter system; and
configuring the gain factor of the power converter system according to a reference voltage and an output voltage across the output port to deliver a substantially constant output power, wherein the gain factor corresponds to a ratio of the output current to the input voltage of the power converter system.

11. The method of claim 10, wherein the gain factor is configured to include a term proportional to (1+(V_{ref}−Vₒᵤₜ)/V_{ref}), wherein V_{ref} corresponds to the reference voltage and Vₒᵤₜ corresponds to the output voltage.

12. An apparatus for controlling gain factor in a power converter system for a lighting device, said apparatus comprising:
a driver device for controlling output current and output voltage supplied to the lighting device;
an input port for coupling a input voltage signal to input of the driver device; and
an output port for coupling output of the driver device to the lighting device;
wherein the driver device comprises means for configuring a gain factor according to the input voltage signal to reduce output current or output power dependency on input voltage amplitude of the input voltage signal, wherein the gain factor corresponds to a ratio of the output current to input voltage of the driver device.

13. The apparatus of claim 12, wherein the gain factor is inversely proportional to the input voltage amplitude.

14. The apparatus of claim 13, wherein the gain factor causes substantially constant output current for the power converter system incorporating non-isolated buck power conversion or causes substantially constant output power for the power converter system incorporating isolated flyback or non-isolated buck-boost power conversion.

15. The apparatus of claim 13, wherein the input voltage amplitude is determined based on the input voltage signal using a peak detector.

16. The apparatus of claim 12, wherein said configuring the gain factor corresponds to adjusting a variable resistance.

17. The apparatus of claim 16, wherein the variable resistance and a first resistor form a voltage divider, and a control signal for power conversion is obtained across the variable resistance.

18. The apparatus of claim 16, wherein the variable resistance is implemented by imposing a force current and a force voltage on a circuit and the circuit comprises at least one MOSFET (metal-oxide-semiconductor field-effect-transistor).

19. The apparatus of claim 12, wherein the gain factor is further configured according to a reference voltage and an output voltage across the output port to deliver a substantially constant output power.

20. The apparatus of claim 12 further comprising coupling the input voltage signal to a dimmer compatibility device to sink required current for proper dimmer operation.
